(19) United States
(12) Patent Application Publication
(10) Pub. No.: US 2022/0340029 A1
(43) Pub. Date: Oct. 27, 2022

(54) SYSTEMS AND METHODS FOR DETERMINING A POSITION OF AN INDIVIDUAL RELATIVE TO AN ELECTRIC VEHICLE CHARGING STATION USING CAMERAS

(71) Applicant: Volta Charging, LLC, San Francisco, CA (US)

(72) Inventors: Andrew B. LIPSHER, New York, NY (US); Jeffrey KINSEY, San Francisco, CA (US)

(73) Assignee: Volta Charging, LLC

(21) Appl. No.: 17/240,220

(22) Filed: Apr. 26, 2021

(51) Int. Cl. B60L 53/30; G06K 9/00

(52) U.S. Cl. CPC B60L 53/305; G06K 9/00771; B60L 2250/22; B60L 2250/16

(57) ABSTRACT

A device detects, using at least one camera, a human subject at a position within a first field of view relative to a first side of at least two sides of a device, the first side displaying first content on a first display of the first side. In response to detecting the human subject at the position within the first field of view, the device generates a first type of impression count for the human subject and tracks, using the camera, motion of the human subject. In accordance with a determination that the human subject moves from the position within the first field of view to a position within a second field of view relative to a second side of the at least two sides, the device updates the first type of impression count to a second type of impression count and stores the respective type of impression count.

### TECHNICAL FIELD

This application relates generally to impression counts, and more particularly, to determining whether an individual has viewed one or more sides of a kiosk (e.g., an electric vehicle charging station) that displays media content.

### BACKGROUND

Electric vehicles are growing in popularity, largely due to their reduced environmental impact and lack of reliance on fossil fuels. These vehicles, however, typically need to be charged more frequently than a gas-powered vehicle would need to be refueled (e.g., every 100 miles as opposed to every 400 miles). As such, the availability of electric vehicle charging stations plays a significant role in users' decisions about where to travel.

Electric vehicle charging stations (EVCSs) typically use charging cables to provide an electrical current and charge a battery of an electric vehicle. The cables and control systems of the EVCSs are housed in kiosks in locations to allow a driver of an electric vehicle to pull the vehicle close to the EVCS and begin the charging process. These kiosks may be placed in areas of convenience, such as in parking lots at shopping centers, in front of commercial buildings, or in other public places. Consequently, passers-by, in addition to users of the EVCS, may notice media content displayed by the EVCS.

### SUMMARY

The disclosed implementations provide systems (e.g., server systems and client devices) and methods of determining different types of impression counts based on how an individual moves relative to a kiosk (e.g., an EVCS).

Typically, impression counts are used by content providers to determine a number of individuals that have been exposed to a particular content item. However, current systems may only provide an estimate of a number of individuals by counting individuals that pass by a particular content item. For example, impression counts may be estimated based on traffic patterns in the area in which a content item is displayed or data collected from a camera that counts a number of individuals that are captured by the camera. Accordingly, systems and methods for providing a more accurate impression count, including providing different types of impression counts based on whether a same individual has been exposed to a plurality of different content items (e.g., or same content displayed at different locations) and/or based on whether a particular individual has been within a particular distance of a content item and/or has gazed at a content item, are needed. In some embodiments, a system is provided that recognizes when a same individual is exposed to the same content multiple times (e.g., when a user walks into a store and out of a store) to avoid repeating an impression count. Providing more accurate and detailed impression count information to content providers improves the quality of feedback provided to the content providers and better informs content providers when making decisions on which content is selected to be displayed at a particular location.

Further, various embodiments are provided for ensuring user privacy while performing the methods described herein. For example, although certain embodiments describe tracking a user's movement from a first side of a device to a second side of a device, some embodiments use an anonymized identifier to track the user, such that the system is aware that someone has moved from the first side to the second side (and can generate an impression count accordingly), but maintains (e.g., stores) no information with respect to that user's identity. In some embodiments, the systems and methods used herein do not use facial recognition to generate impression counts, further ensuring user privacy.

In accordance with some implementations, a method for generating different types of impression counts is provided. The method is performed at a device having at least one camera and at least two sides (e.g., a body having at least two sides), each side including a respective display. The method includes detecting, using the at least one camera, a human subject at a position within a first field of view relative to a first side of the at least two sides, the first side displaying first content on a first display of the first side. The method further includes, in response to detecting the human subject at the position within the first field of view relative to the first side, generating a first type of impression count for the human subject and tracking, using the camera, motion of the human subject. The method includes, after detecting the human subject at the position within the first field of view relative to the first side, in accordance with a determination that the human subject moves from the position within the first field of view relative to the first side of the device to a position within a second field of view relative to a second side of the at least two sides, updating the first type of impression count to a second type of impression count. The method further includes storing the respective type of impression count.

Some implementations of the present disclosure provide a device (e.g., an EVCS, a server system, etc.), comprising one or more processors and memory storing one or more programs. The one or more programs store instructions that, when executed by the one or more processors, cause the device to perform any of the methods described herein.

Some implementations of the present disclosure provide a computer program product (e.g., a non-transitory computer readable storage medium storing instructions) that, when executed by a device having one or more processors, cause the computer system to perform any of the methods described herein.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 illustrates a system for charging an electric vehicle in accordance with some implementations.

FIGS. 2A-2C illustrate a charging station for an electric vehicle in accordance with some implementations.

FIG. 3 is a block diagram of a server system in accordance with some implementations.

FIG. 4 is a block diagram of a charging station for an electric vehicle in accordance with some implementations.

FIG. 5 is a block diagram of a user device in accordance with some implementations.

FIGS. 6A-6B illustrate different example scenarios for generating impression counts, in accordance with some embodiments.

FIGS. 7A-7C illustrate a flowchart of a method of determining a type of impression count based on movement of an individual, in accordance with some implementations.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

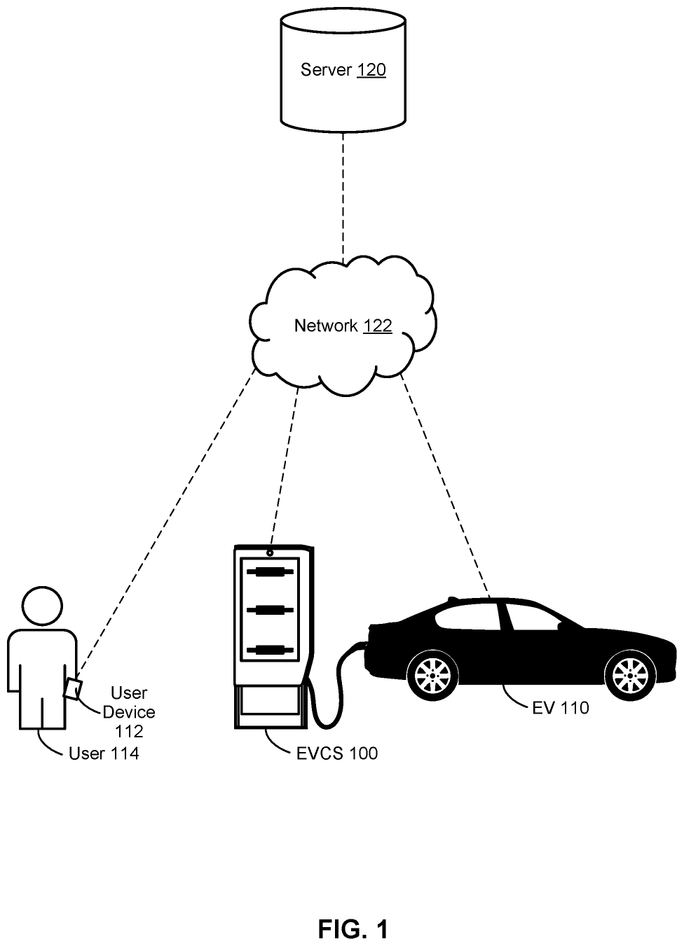

FIG. 1 illustrates an electric vehicle charging station (EVCS) 100 that is configured to provide an electric charge to an electric vehicle 110 via one or more electrical connections. In some implementations, the EVCS 100 provides an electric charge to electric vehicle 110 via a wired connection, such as a charging cable. Alternatively, the EVCS 100 may provide an electric charge to electric vehicle 110 via a wireless connection (e.g., wireless charging). In some implementations, the EVCS 100 may be in communication with the electric vehicle 110 or a user device 112 belonging to a user 114 (e.g., a driver, passenger, owner, renter, or other operator of the electric vehicle 110) that is associated with the electric vehicle 110. In some implementations, the EVCS 100 communicates with one or more devices or computer systems, such as user device 112 or server 120, respectively, via a network 122.

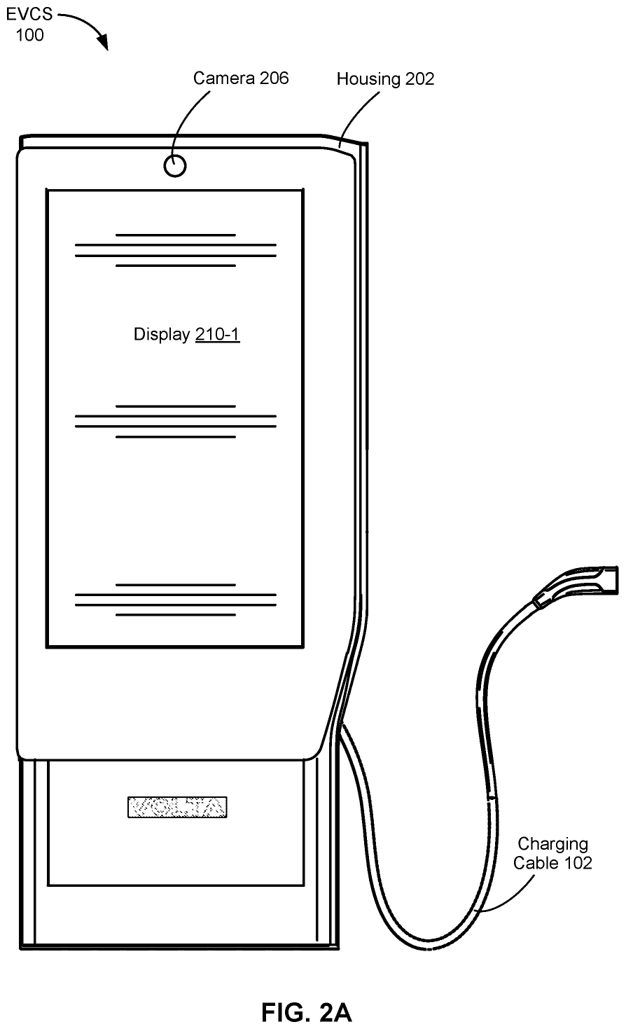

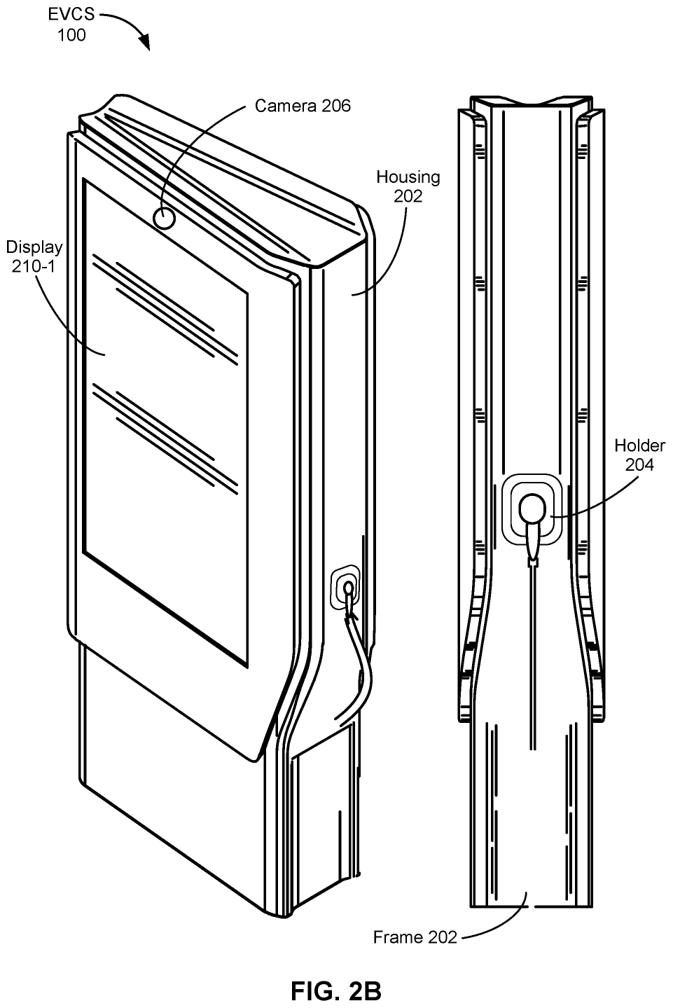

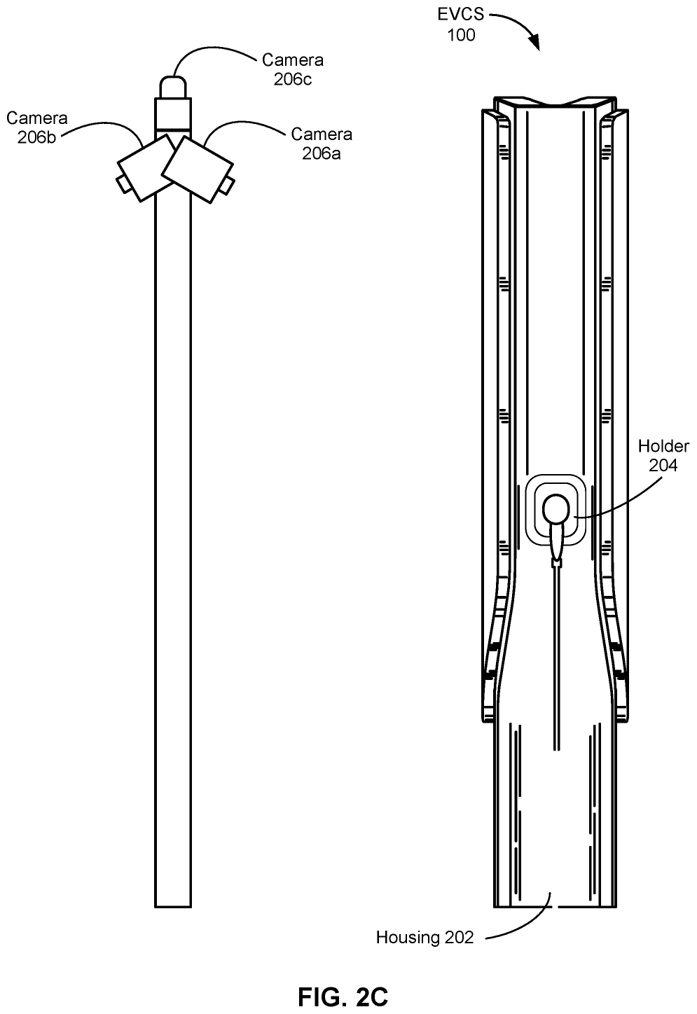

FIG. 2A is a mechanical drawing showing various views of an electric vehicle charging station (EVCS) 100, in accordance with some implementations. FIG. 2B is a mechanical drawing showing additional views of the EVCS 100 of FIG. 2A, in accordance with some implementations. FIG. 2C shows an alternative configuration of EVCS 100, in accordance with some implementations. FIGS. 2A-2C are discussed together below.

EVCS 100 includes a housing 202 (e.g., a body or a chassis) including a charging cable 102 (e.g., connector) configured to connect and provide a charge to an electric vehicle 110 (FIG. 1). An example of a suitable connector is an IEC 62196 type-2 connector. In some implementations, the connector is a “gun-type” connector (e.g., a charge gun) that, when not in use, sits in a holder 204 (e.g., a holster). In some implementations, the housing 202 houses circuitry for charging an electric vehicle 110. For example, in some implementations, the housing 202 includes power supply circuitry as well as circuitry for determining a state of a vehicle being charged (e.g., whether the vehicle is connected via the connector, whether the vehicle is charging, whether the vehicle is done charging, etc.).

The EVCS 100 further includes one or more displays 210 facing outwardly from a surface of the EVCS 100. For example, the EVCS 100 may include two displays 210, one on each side of the EVCS 100, each display 210 facing outwardly from the EVCS 100. In some implementations, the one or more displays 210 display messages (e.g., media content) to users of the charging station (e.g., operators of the electric vehicle) and/or to passersby that are in proximity to the EVCS 100. In some implementations, the 210 has a height that is at least 60% of a height of the housing 202 and a width that is at least 90% of a width of the housing 202. In some implementations, the panel 102 has a height that is at least 3 feet and a width that is at least 2 feet.

In some implementations, the EVCS 100 includes one or more panels that hold a display 210. The displays are large compared to the housing 202 (e.g., 60% or more of the height of the frame and 80% or more of the width of the frame), allowing the displays 210 to function as billboards, capable of conveying information to passersby. In some implementations, the displays 210 are incorporated into articulating panels that articulate away from the housing 202 (e.g., a sub-frame). The articulating panels solve the technical problem of the need for maintenance of the displays 210 (as well as one or more computers that control content displayed on the display). To that end, the articulating panels provide easy access to the entire back of the displays 210. In addition, in some implementations, the remaining space between the articulating panels (e.g., within the housing 202) is hollow, allowing for ample airflow and cooling of the displays 210.

The EVCS 100 further includes a computer that includes one or more processors and memory. The memory stores instructions for displaying content on the display 210. In some implementations, the computer is disposed inside the housing 202. In some implementations, the computer is mounted on a panel that connects (e.g., mounts) a first display (e.g., a display 210) to the housing 202. In some implementations, the computer includes a near-field communication (NFC) system that is configured to interact with a user's device (e.g., user device 112 of a user 114 of the EVCS 100).

In some implementations, the EVCS 100 includes one or more sensors (not shown) for detecting whether external objects are within a predefined region (area) proximal to the housing. For example, the area proximal to the EVCS 100 includes one or more parking spaces, where an electric vehicle 110 parks in order to use the EVCS 100. In some implementations, the area proximal to the EVCS 100 includes walking paths (e.g., sidewalks) next to the EVCS 100. In some implementations, the one or more sensors are configured to determine a state of the area proximal to the EVCS 100 (e.g., wherein determining the state includes detecting external objects). The external objects can be living or nonliving, such as people, kids, animals, vehicles, shopping carts, (kids) toys, etc. The one or more sensors can detect stationary or moving external objects. The one or more sensors of the EVCS 100 include one or more image (e.g., optical) sensors (e.g., one or more cameras 206), ultrasound sensors, depth sensors, IR/RGB cameras, PIR, heat IR, proximity sensors, radar, and/or tension sensors. The one or more sensors may be connected to the EVCS 100 or a computer system associated with the EVCS 100 via wired or wireless connections such as via a Wi-Fi connection or Bluetooth connection.

In some implementations, the housing 202 includes one or more lights configured to provide predetermined illumination patterns indicating a status of the EVCS 100. In some implementations, at least one of the one or more lights is configured to illuminate an area proximal to the EVCS 100 as a person approaches the area (e.g., a driver returning to a vehicle or a passenger exiting a vehicle that is parked in a parking spot associated with the EVCS 100).

In some implementations, the housing 202 includes one or more cameras 206 configured to capture one or more images of an area proximal to the EVCS 100. In some implementations, the one or more cameras 206 are configured to obtain video of an area proximal to the EVCS 100. For example, a camera may be configured to obtain a video or capture images of an area corresponding to a parking spot associated with the EVCS 100. In another example, another camera may be configured to obtain a video or capture images of an area corresponding to a parking spot next to the parking spot of the EVCS 100. In a third example, the camera 206 may be a wide angle camera or a 360° camera that is configured to obtain a video or capture images of a large area proximal to the EVCS 100, including a parking spot of the EVCS 100. As shown in FIG. 2B, the one or more cameras 206 may be mounted directly on a housing 202 of the EVCS 100 and may have a physical (e.g., electrical, wired) connection to the EVCS 100 or a computer system associated with the EVCS 100. Alternatively, as shown in FIG. 2C, the one or more cameras 206 (or other sensors) may be disposed separately from but proximal to the housing 202 of the EVCS 100. In some implementations, the camera 206 may be positioned at different locations on the EVCS 100 than what is shown in the figures. Further, in some implementations, the one or more cameras 206 include a plurality of cameras positioned at different locations on the EVCS 100.

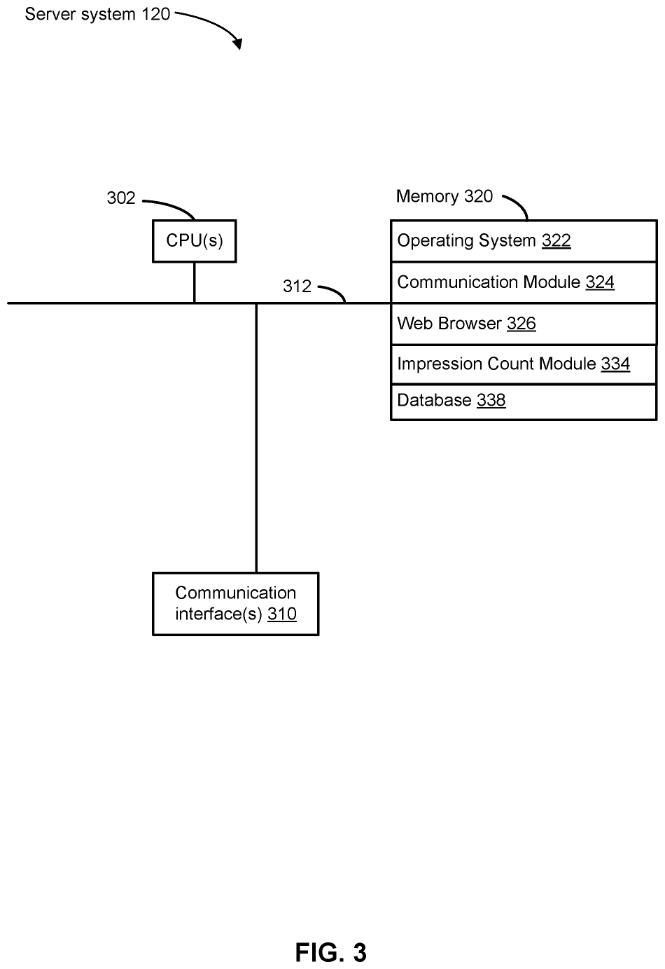

FIG. 3 is a block diagram of a server system 120, in accordance with some implementations. Server system 120 may include one or more computer systems (e.g., computing devices), such as a desktop computer, a laptop computer, and a tablet computer. In some implementations, the server system 120 is a data server that hosts one or more databases (e.g., databases of images or videos), models, or modules or may provide various executable applications or modules. The server system 120 includes one or more processing units (processors or cores, CPU(s)) 302, one or more network or other communications network interfaces 310, memory 320, and one or more communication buses 312 for interconnecting these components. The communication buses 312 optionally include circuitry (sometimes called a chipset) that interconnects and controls communications between system components.

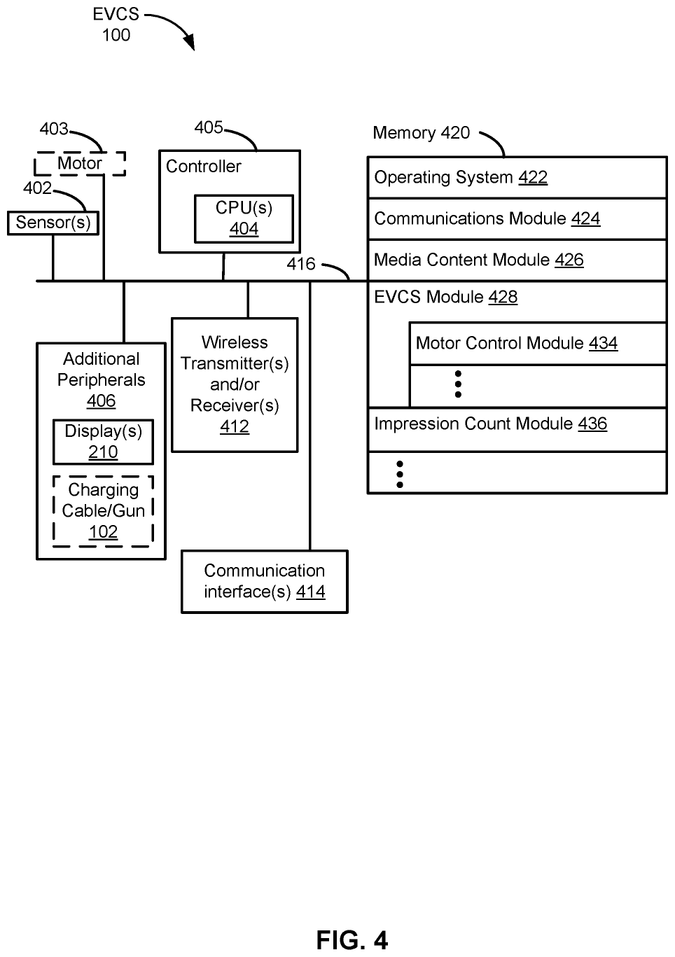

The memory 320 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 320 includes one or more storage devices remotely located from the processors 302. The memory 320, or alternatively the non-volatile memory devices within the memory 320, includes a non-transitory computer-readable storage medium. In some implementations, the memory 320 or the computer-readable storage medium of the memory 320 stores the following programs, modules, and data structures, or a subset or superset thereof:
an operating system 322, which includes procedures for handling various basic system services and for performing hardware dependent tasks;
a communications module 324, which is used for connecting the server system 120 to other computers and devices via the one or more communication network interfaces 310 (wired or wireless), such as the internet, other wide area networks, local area networks, metropolitan area networks, and so on;
a web browser 326 (or other application capable of displaying web pages), which enables a user to communicate over a network with remote computers or devices;
an impression count module 334 for storing impression count types, as received from EVCS impression count module 436 (FIG. 4), and/or analyzing data associated with impression count types for respective media content items, the data to be accessed by content providers;
database 338 for storing information on electric vehicle charging stations, their locations, media content displayed at respective electric vehicle charging stations, a number of each type of impression count associated with respective electric vehicle charging stations, and so forth.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 320 stores a subset of the modules and data structures identified above. Furthermore, the memory 320 may store additional modules or data structures not described above.

Although FIG. 3 shows a server system 120, FIG. 3 is intended more as a functional description of the various features that may be present rather than as a structural schematic of the implementations described herein. In practice, and as recognized by those of ordinary skill in the art, items shown separately could be combined and some items could be separated.

FIG. 4 is a block diagram of an EVCS 100 (FIGS. 1 and 2A-2C) for charging an electric vehicle, in accordance with some implementations. The EVCS 100 optionally includes a motor 403 (configured to retract a portion of a charging cable), a controller 405 that includes one or more processing units (processors or cores) 404, one or more network or other communications network interfaces 414, memory 420, one or more wireless transmitters and/or receivers 412, one or more sensors 402, additional peripherals 406, and one or more communication buses 416 for interconnecting these components. The communication buses 416 optionally include circuitry (sometimes called a chipset) that interconnects and controls communications between system components. In some implementations, the memory 420 stores instructions for performing (by the one or more processing units 404) a set of operations, including determining a type of impression count to assign to an individual detected by the one or more sensors of the EVCS.

EVCS 100 typically includes additional peripherals 406 such as displays 210 for displaying content, and charging cable 102. In some implementations, the displays 210 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

The user interface may also include one or more sensors 402 such as cameras (e.g., camera 206, described above with respect to FIGS. 2A-2B), ultrasound sensors, depth sensors, infrared cameras, visible (e.g., RGB or black and white) cameras, passive infrared sensors, heat detectors, infrared sensors, proximity sensors, or radar. In some implementations, the one or more sensors 402 are for detecting whether external objects are within a predefined region proximal to the housing, such as living and nonliving objects, and/or the status of the EVCS 100 (e.g., available, occupied, etc.) in order to perform an operation, such as determining a position of an individual relative to the EVCS to use to determine a type of impression count.

The memory 420 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 420 includes one or more storage devices remotely located from the processors 404, such as database 338 of server system 120 that is in communication with the EVCS 100. The memory 420, or alternatively the non-volatile memory devices within the memory 420, includes a non-transitory computer-readable storage medium. In some implementations, the memory 420 or the computer-readable storage medium of the memory 420 stores the following programs, modules, and data structures, or a subset or superset thereof:
an operating system 422, which includes procedures for handling various basic system services and for performing hardware dependent tasks;
a communications module 424, which is used for connecting the EVCS 100 to other computers and devices via the one or more communication network interfaces 414 (wired or wireless), such as the internet, other wide area networks, local area networks, metropolitan area networks, and so on;
a media content module 426 for selecting and/or displaying media content on the display(s) 210 to be viewed by passersby and users of the EVCS 100;
an EVCS module 428 for charging an electric vehicle (e.g., measuring how much charge has been delivered to an electric vehicle, commencing charging, ceasing charging, etc.), including a motor control module 434 that includes one or more instructions for energizing or forgoing energizing the motor; and
an impression count module 436 for determining, based on data collected from one or more sensor(s) 402, a type of impression count associated with a respective individual and/or for storing (and/or transmitting to a server system 120) the type of impression count, and other information related to the type of impression count.

In some implementations, the memory 420 stores metrics, thresholds, and other criteria, which are compared against the measurements captured by the one or more sensors 402. For example, data obtained from a PIR sensor of the one or more sensors 402 can be compared with baseline data to detect that an object is in proximity the EVCS 100.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 420 stores a subset of the modules and data structures identified above. Furthermore, the memory 420 may store additional modules or data structures not described above.

Although FIG. 4 shows an EVCS 100, FIG. 4 is intended more as a functional description of the various features that may be present rather than as a structural schematic of the implementations described herein. In practice, and as recognized by those of ordinary skill in the art, items shown separately could be combined and some items could be separated.

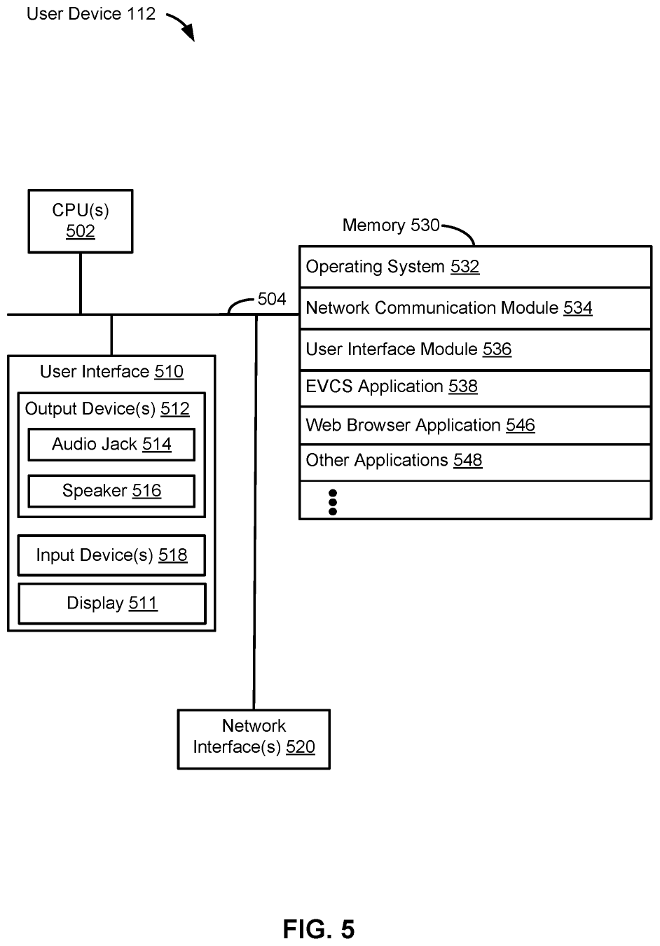

FIG. 5 is a block diagram of a user device 112 of a user 114 in accordance with some implementations. In some implementations, the user 114 is associated with (e.g., an operator of) an electric vehicle 110 at EVCS 100. Various examples of the computing device 112 include a cellular-capable smart device such as a smartphone, a smart watch, a laptop computer, a tablet computer, and other computing devices that have a processor capable of connecting to the EVCS 100 via a communications network (e.g., network 122).

The user device 112 typically includes one or more processing units (processors or cores) 502, one or more network or other communications network interfaces 520, memory 530, and one or more communication buses 504 for interconnecting these components. The communication buses 504 optionally include circuitry (sometimes called a chipset) that interconnects and controls communications between system components. The user device 112 typically includes a user interface 510. The user interface 510 typically includes one or more output devices 512 such as an audio output device 514, such as speakers 516 or an audio output connection (e.g., audio jack) for connecting to speakers, earphones, or headphones. The user interface 510 also typically includes a display 511 (e.g., a screen or monitor). In some implementations, the user device 112 includes input devices 518 such as a keyboard, mouse, and/or other input buttons. Alternatively or in addition, in some implementations, the user device 112 includes a touch-sensitive surface. In some embodiments, the touch-sensitive surface is combined with the display 511, in which case the display 511 is a touch-sensitive display. In some implementations, the touch-sensitive surface is configured to detect various swipe gestures (e.g., continuous gestures in vertical and/or horizontal directions) and/or other gestures (e.g., single/double tap). In computing devices that have a touch-sensitive surface (e.g., a touch-sensitive display), a physical keyboard is optional (e.g., a soft keyboard may be displayed when keyboard entry is needed). Furthermore, user device 112 may also include a microphone and voice recognition software to supplement or replace the keyboard.

The memory 530 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 530 includes one or more storage devices remotely located from the processors 502. The memory 530, or alternatively the non-volatile memory devices within the memory 530, includes a non-transitory computer-readable storage medium. In some implementations, the memory 530 or the computer-readable storage medium of the memory 530 stores the following programs, modules, and data structures, or a subset or superset thereof:
an operating system 532, which includes procedures for handling various basic system services and for performing hardware dependent tasks;
a network communication module 534, which is used for connecting the user device 112 to other computers and devices via the one or more communication network interfaces 520 (wired or wireless), such as the internet, other wide area networks, local area networks, metropolitan area networks, and so on;
a user interface module 536 for providing user interfaces for the user to interact with the user device 112 via applications on the user device 112 and the operating system 532 of the user device 112;
an EVCS mobile application 538 for communicating with an EVCS 100 or a server system that supports the EVCS 100. In some embodiments, the EVCS mobile application 538 is capable of transmitting user information (e.g., account profile, payment information, demographic information, etc.) to the EVCS 100 or server system. in some embodiments, mobile application 538 transmits a location of the user device 112 (e.g., to indicate a proximity between the user device 112 and a respective EVCS);
a web browser application 546 for accessing the internet and accessing websites on the internet, including providing functionalities on the EVCS mobile application 538 via a website accessed through web browser application 546; and
other applications 548 that the user 114 may have installed on the user device 112 or that may have been included as default applications on the user device 112.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 530 stores a subset of the modules and data structures identified above. Furthermore, the memory 530 may store additional modules or data structures not described above.

Although FIG. 5 shows a user device 112, FIG. 5 is intended more as a functional description of the various features that may be present rather than as a structural schematic of the implementations described herein. In practice, and as recognized by those of ordinary skill in the art, items shown separately could be combined and some items could be separated.

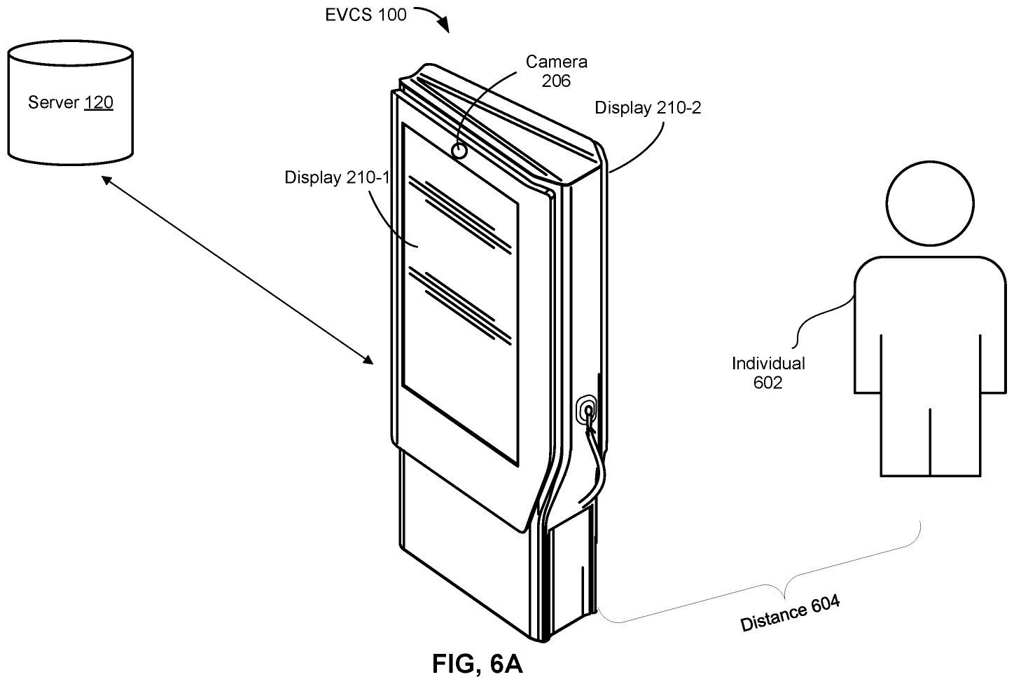

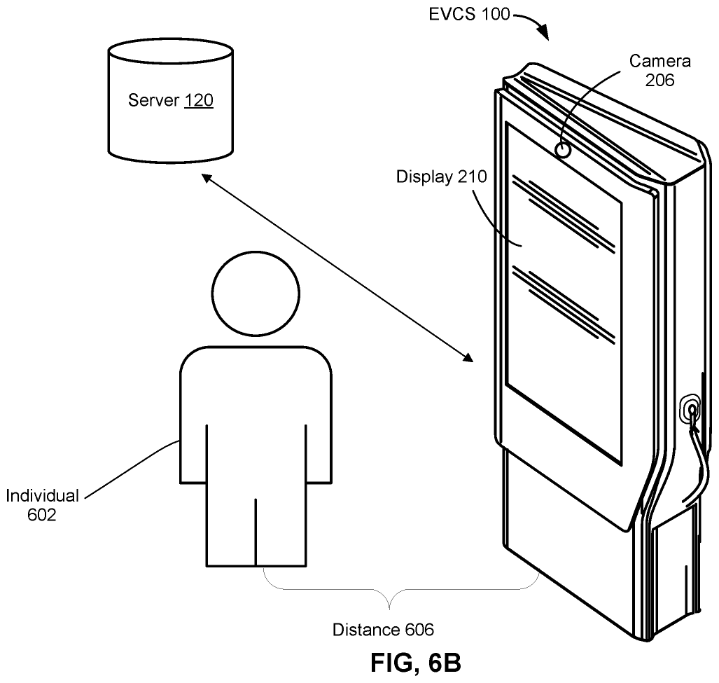

FIG. 6A illustrates an electric vehicle charging station determining a position of an individual 602. The EVCS 100 includes a body having at least two sides (e.g., at least two faces), including a first side with a first display (e.g., display 210-2) and a second side (e.g., substantially parallel to the first side) with a second display (e.g., display 210-1). In some embodiments, the content displayed on the display(s) of EVCS is determined based in part on individuals (e.g., passersby near the EVCS and/or users that use the EVCS to charge an electric vehicle), such as individual 602. Because display 210-1 and display 210-2 can be updated independently (e.g., such that content on the displays can be the same content, different content, and/or related content), there is a need to determine whether an individual has approached one of the sides (e.g., and has viewed the content on the display of the respective side), or if the individual has approached more than one of the sides, in order to collect an improved impression count for a particular individual and to provide more personalized content on the display based on what the individual has already viewed.

In some embodiments, determining the position of individual 602 includes determining a distance 604 between the individual and the EVCS. In some embodiments, the EVCS 100 uses camera 206 to determine the position of individual 602. In some embodiments, the EVCS 100 uses other types of sensors and/or detectors to determine information related to the position of individual 602. In some embodiments, EVCS 100 uses gaze detection to determine whether individual 602 is gazing (e.g., looking) at the EVCS 100 (e.g., at display 210-2 of EVCS 100). For example, the EVCS 100 uses cameras to measure eye positions of an individual's eye(s). In some embodiments, EVCS 100 determines, based on the measured eye position, a location of the individual's gaze. In some embodiments, EVCS 100 determines whether the individual's gaze (e.g., for at least a threshold amount of time) is incident upon a particular location (e.g., corresponding to a display of the EVCS 100). Unlike facial recognition, which identifies a particular individual based on a plurality of facial features detected by cameras, gaze detection does not perform a lookup to identify an individual. In some embodiments, because gaze detection tracks whether the individual has focused on the display of the EVCS (e.g., and determines that the individual has thus looked at the content displayed on EVCS 100), a first type of impression count is stored for a first individual for whom a gaze has been detected while a second type of impression count (e.g., distinct from the first type of impression count) is stored for a second individual detected within the vicinity of EVCS 100 for whom a gaze has not been detected.

In some embodiments, the individual 602 has a user device (e.g., user device 112), and the EVCS determines the position (e.g., and/or an identity) of the individual based on a signal detected from user device 112. For example, EVCS application 538 of user device 112 transmits a signal (e.g., beacon signal) that is received by EVCS 100 such that EVCS 100 (or a server system associated with the EVCS) determines that the individual is within a proximity (e.g., a signal-receiving proximity) of the EVCS. In some embodiments, the signal is transmitted with a predefined power, wherein the predefined power is calibrated to define the proximity (e.g., selected such that users within a predefined distance will receive the signal). Note, here, that more power is not necessarily better: in some circumstances, it is advantageous to set the power such that only user's within, e.g., ten meters receive the signal (or another predefined distance, as described below), because the signal is then indicative of stronger impression count. In some embodiments, to ensure user privacy and agency, beacon signals received by the user's device are only used to track the user after the user has expressly consented (e.g., through a user interface of their device).

In some embodiments, in response to determining that the position of the individual satisfies criteria (e.g., that the distance 604 satisfies a threshold distance), the EVCS 100 assigns a first type of impression count to individual 602. For example, an individual must be within a certain predefined distance (e.g., 15 feet, 20 feet, etc.) for the EVCS 100 to assign the individual an impression count (e.g., a first type of impression count). In some embodiments, the first type of impression count that is assigned to the respective individual is based on criteria that are satisfied by the respective individual. For example, the criteria can include one or more of a distance between the individual and the EVCS, whether the individual gazed at the EVCS, a time threshold that the individual was located within a predefined area, a time threshold that the individual gazed at the EVCS, etc. In some embodiments, a plurality of types of impression counts are defined for the EVCS, such that the EVCS determines, for a respective individual, which of the plurality of types of impression counts to assign to the individual (e.g., at least two distinct types of impression counts are predefined).

In some embodiments, the EVCS 100 stores the first type of impression count (e.g., selected from the plurality of possible types of impression counts that may be assigned to the individual based on the criteria that the individual has satisfied). In some embodiments, the EVCS 100 transmits, to a server 120, an indication of the first type of impression count (e.g., an indication that an individual has been assigned the first type of impression count). In some embodiments, the EVCS 100 transmits additional information related to the first type of impression count, for example, a timestamp at which the impression count was detected by the EVCS, a content identifier identifying content that was displayed when the impression count was detected, information about the individual that is collected by the EVCS (e.g., determined by data collected using the one or more sensor(s) of EVCS and/or using information received from a signal from a user device 112), and/or information about the movement of the individual (e.g., a position (proximity) of the individual relative to the EVCS and/or an amount of time the individual was detected at different positions). In some embodiments, EVCS 100 stores the first type of impression count and/or the additional information related to the individual for the impression count (e.g., within memory of the EVCS).

In some embodiments, as the individual 602 moves within an area (e.g., within an area that includes the field of view of camera 206 and/or the field of view of any other camera of the EVCS), the camera 206 of EVCS 100 tracks the movement of the individual (e.g., while the individual 602 is in the area). In some embodiments, the area is defined by a field of view of the EVCS (e.g., 360 degrees around the EVCS 100), for example, a plurality of images are captured (e.g., by camera 206 and/or other camera(s) of the EVCS 100) and the plurality of images (e.g., corresponding to a same point in time) are stitched together to generate the 360 degree view. In some embodiments, the area is defined by a distance from EVCS 100 (e.g., a radius around EVCS 100 as determined by a distance captured by the one or more cameras of EVCS 100).

In some embodiments, the camera 206 determines (e.g., by analyzing the image that was stitched together) whether the individual 602 passes by a first side of the EVCS (e.g., the side including display 210-2, as illustrated in FIG. 6A).

In some embodiments, the camera 206 (e.g., and/or other camera(s) of EVCS 100) captures an image that is used by the EVCS to identify if the individual has left the area (e.g., the individual has moved outside of the field of view of camera 206 and/or any other camera of the EVCS). In some embodiments, the camera 206 recognizes when the individual returns to the area. For example, the EVCS 100 processes image data captured by camera 206 to determine (e.g., estimate) features of the individual (e.g., height, color of clothing, age, etc.) that allows EVCS 100 to recognize if a same individual has returned to the area after the individual has left the area (e.g., within a threshold amount of time, such as 30 seconds or 5 minutes). In some embodiments, the features of the individual are associated by the EVCS 100 (or a server system associated with the EVCS 100) with an anonymized identifier. Thus, the EVCS 100 can determine that someone has returned to the EVCS but does not store any information on that user's identity. In some embodiments, the EVCS 100 identifies an individual based on signals received from the user device 112 of the individual. For example, the EVCS 100 transmits beacon signals and/or other wireless signals (e.g., with the user's consent) that, when the individual is within the area, a user device of the individual receives and, in some embodiments, transmits a signal that EVCS 100 receives and uses to identify the individual. It will be understood that in some embodiments, the identification of the individual is anonymized (e.g., individual 1, individual 2, etc.). In some embodiments, the identification of the individual is associated with a particular user (e.g., in accordance with user information obtained via the user device signal).

In some embodiments, the camera 206 (e.g., and/or other camera(s) of EVCS 100) captures images of the individual 602 at a second location within the area (a distance 606 from the EVCS 100), as illustrated in FIG. 6B. For example, EVCS 100 determines that individual 602 is at a second position near the second side of EVCS 100 in FIG. 6B. In some embodiments, the EVCS 100 captures a stream of images as the individual 602 moves within the area (e.g., the area within the field of view of the camera(s) 206) and determines when the individual 602 has moved from a portion of the area situated in front of the first side of EVCS 100 to a portion of the area situated in front of the second side of EVCS 100. For example, the EVCS 100 determines that the individual has been exposed to both the first side and the second side based on the positions of the individual as captured by camera 206. In some embodiments, EVCS 100 also determines (e.g., and stores) timestamps associated with the individual at different positions relative to the EVCS 100 (e.g., to track an amount of time the individual spent at a particular position within the field of view of the camera 206).

In some embodiments, the EVCS determines that an individual is at a position in front of the first side without the individual moving to a position in front of the second side. In accordance with the determination that the individual has not moved to a position in front of the second side, the impression count remains as the first type of impression count (e.g., corresponding to an impression count of the individual being within a threshold distance from the first side).

In some embodiments, in response to the individual 602 moving from the position in front of the first side of EVCS 100 to a position in front of the second side of EVCS 100, the EVCS 100 updates the type of impression count from the first type of impression count to a second type of impression count. For example, the second type of impression count indicates that the individual has been exposed (e.g., the individual is detected within a threshold distance from) the first side and the second side of the EVCS 100. In some embodiments, the second type of impression count is given more weight (e.g., corresponding to greater value to the content providers (e.g., advertisers)) by indicating that the individual has been exposed to first content displayed on the first side and second content displayed on the second side. Improving the accuracy of impression counts provides better feedback to content providers on which content is likely to create interest in an individual such that the individual repositions themselves to see additional content (e.g., on the second side).

For example, an individual 602 is exposed to first content on display 210-2 and becomes interested in the first content. In some embodiments, the individual 602 moves (e.g., walks) to a second position in front of display 210-1 (e.g., the second side of EVCS 100) in order to learn more about the first content. This indicates that the first content piqued the individual's interest, and thus warrants a stronger impression count. In some embodiments, display 210-1 displays content related to the content displayed on display 210-2. In some embodiments, in accordance with a determination that individual 602 has moved from a position in front of the first side to a position in front of the second side of EVCS 100, the EVCS 100 updates the content displayed on the second side (e.g., display 210-1) for the individual. For example, display 210-1 displays more detailed information about a same product that was displayed on display 210-2. In some embodiments, display 210-1 displays the same content displayed on display 210-2. In some embodiments, display 210-2 displays video content as individual 602 is in an area in front of display 210-2, and in accordance with a determination that the individual moves out of the area in front of display 210-2 and into the area in front of display 210-1, the video content is paused on display 210-2 and resumed on display 210-1 (e.g., as if to play a continuous video for individual 602).

In some embodiments, the type of impression count is updated based at least in part on whether the camera 206 detects that an individual is gazing at the EVCS 100. For example, a different type (e.g., a third type) of impression count is stored in accordance with a determination that an individual has gazed at the first side (e.g., at content displayed on the first side) than the first type of impression count that is stored in accordance with a determination that the individual is within the predefined area of the first side (e.g., is within a threshold distance from the first side of EVCS 100). Accordingly, EVCS 100 stores the first type of impression count for the individual in accordance with the individual being within a predefined distance of the first side, and continues updating the type of impression count as the EVCS 100 continues collecting data on the individual (e.g., whether the individual has gazed at the content (to update to the third type of impression count) and/or whether the individual has moved to a position in front of another side of the EVCS (to update to the second type of impression count)).

In some embodiments, more than one individual is detected by camera 206 at a same time. In some embodiments, the EVCS tracks each of the individuals separately (e.g., independently) and generates types of impression counts for each individual of the plurality of individuals.

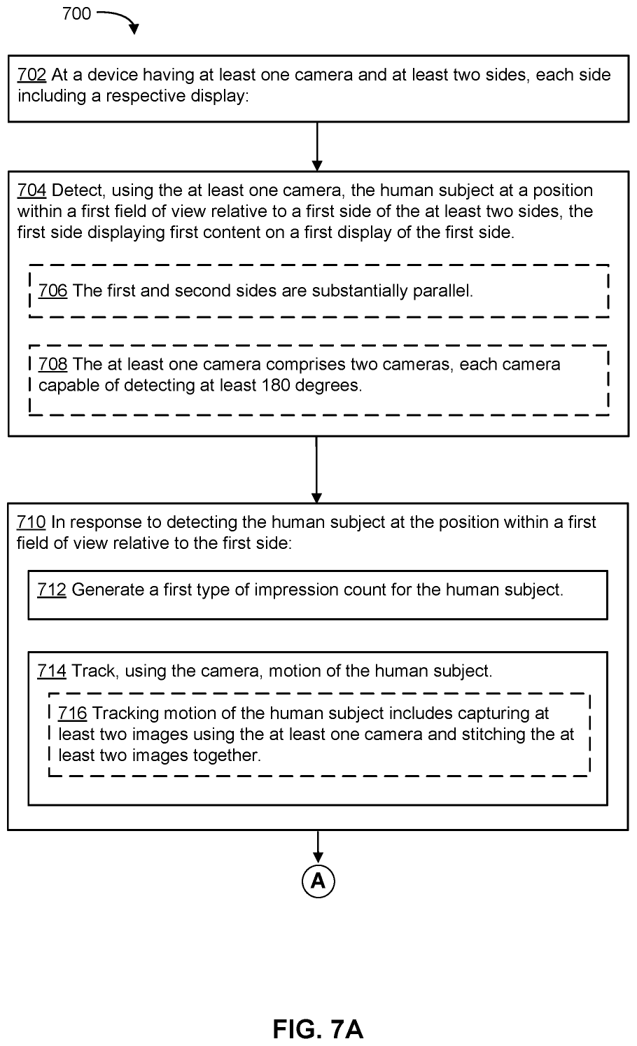

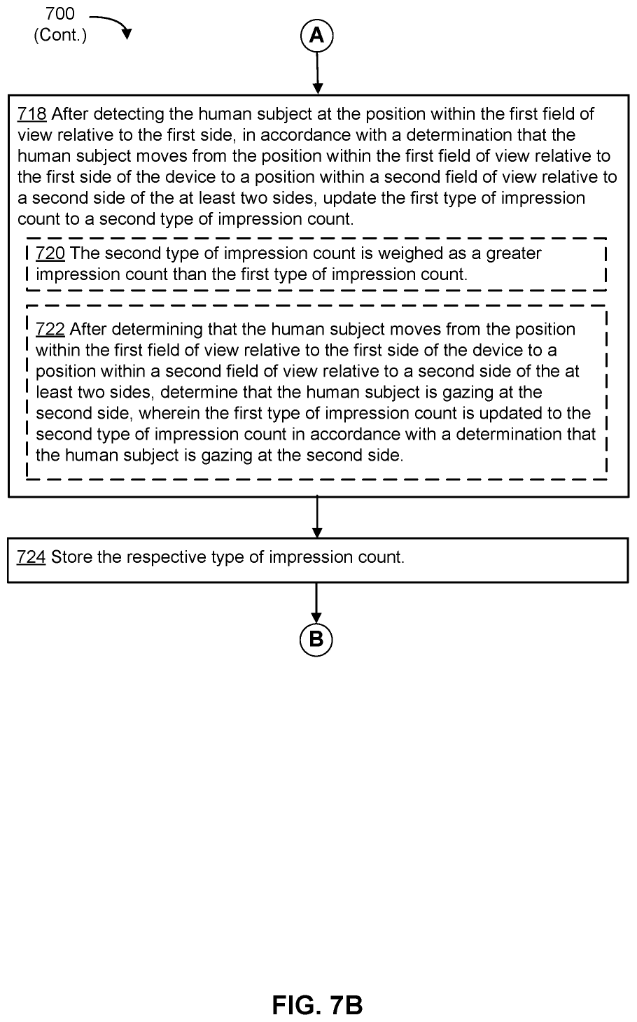

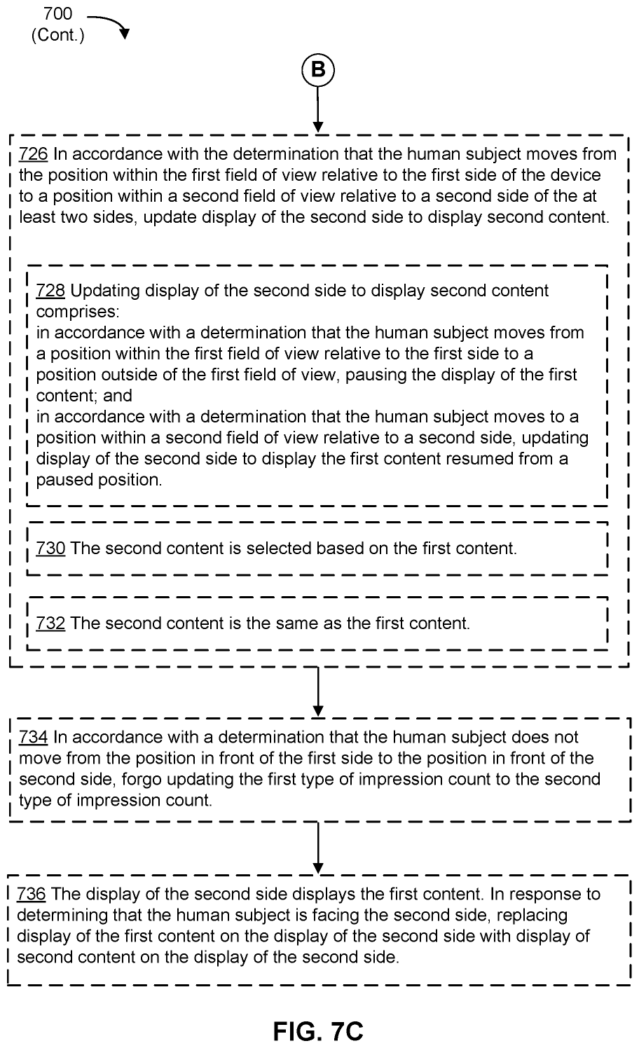

FIGS. 7A-7C illustrate a flowchart of a method 700 of storing different types of impression counts, in accordance with some implementations. The method 700 is performed at a device with one or more processors, and memory (e.g., EVCS 100, FIG. 1). The device has (702) at least one camera and at least two sides (e.g., includes a body that has at least two sides), each side (e.g., face) including a respective display (e.g., 210-1 and 210-2). In some embodiments, the device includes four sides, wherein at least two of the sides are opposing (e.g., and substantially parallel). In some embodiments, the at least one camera is capable of detecting at least 180 degrees (e.g., the field of view of the camera is 180 degrees relative to the first side). In some embodiments, the first display of the first side takes up at least 70% of the first side. For example, the first display is large enough to display content to individuals passing by the first display.

The device detects (704), using the at least one camera, a human subject (e.g., an individual) at a position within a first field of view relative to a first side of the at least two sides, the first side displaying first content on a first display of the first side. In some embodiments, the first field of view relative to the first side comprises a proximity in which the human subject can view (e.g., see, read, etc.) the first content on the first display of the first side.

In some embodiments, the first and second sides are (706) substantially parallel. In some embodiments, additional sides of the device also include displays (e.g., smaller displays than the displays illustrated in FIGS. 6A-6B). For example, a display is included on the side that includes holder 204 for the charging cable (as illustrated in FIG. 2B).

In some embodiments, the at least one camera comprises (708) two cameras, each camera capable of detecting at least 180 degrees for a predefined distance (e.g., corresponding to a radius of a predefined area). For example, the second camera has a field of view that is at least 180 degrees relative to the second side. Accordingly, the combination of camera(s) allows for a 360 degree field of view relative to the device. For example, the device stitches images from the two cameras to create a 360-degree field of view around the device. In some embodiments, the device has only one camera that is capable of capturing a field of view that comprises 360 degrees around the device (e.g., the EVCS).

In response to detecting the human subject at the position within a first field of view relative to the first side (710), the device generates (712) a first type of impression count for the human subject and tracks (714), using the camera, motion of the human subject. For example, the camera 206 detects when an individual is within the field of view of the camera 206, and in accordance with a determination that the individual is within a predefined distance of (or predefined area surrounding) the first side of the device, the device generates a first type of impression count (e.g., the first type of impression count indicates the individual is within the predefined area of the first side of the device). In some embodiments, the device generates the first type of impression count (e.g., or another type of impression count distinct from the first type of impression count, such as a third type of impression count) in accordance with a determination that camera 206 detects that the individual has gazed at the first side of the device.

In some embodiments, tracking motion of the human subject includes capturing (716) at least two images using the at least one camera and stitching the at least two images together. For example, when a plurality of cameras are used to capture a field of view that includes 360 degrees surrounding the device, the device stitches the images captured by the plurality of cameras together to create a continuous image that is able to track motion of the individual as the individual moves relative to the device.

In some embodiments, tracking of the human subject is performed in an anonymized manner, such that the device is aware that a human subject has moved within and around the EVCS, but maintains (e.g., stores) no information with respect to the user's identity. In some embodiments, an anonymized identifier is used to track the human subject.

After detecting the human subject at the position within the first field of view relative to the first side and in accordance with a determination that the human subject moves from the position within the first field of view relative to the first side of the device to a position within a second field of view relative to a second side of the at least two sides, the device updates (718) the first type of impression count to a second type of impression count. For example, as illustrated in FIG. 6B, in response to the device determining (e.g., based on images captured from camera 206) that the individual has moved from a predefined area in front of the first side of the device to a predefined area in front of the second side of the device, the device generates a second type of impression count distinct from the first type of impression count. In some embodiments, the second type of impression count overwrites (e.g., replaces) the first type of impression count. For example, the first type of impression count is updated to the second type of impression count, where the second type of impression count indicates the same individual has been in predefined areas in front of the first side and the second side (e.g., whereas the first type of impression count indicates the individual has only been detected in one of the predefined areas (e.g., in front of the first side or the second side)).

In some embodiments, the second type of impression count is weighed (720) as a greater impression count than the first type of impression count.

In some embodiments, after determining that the human subject moves from the position within the first field of view relative to the first side of the device to a position within a second field of view relative to a second side of the at least two sides, the device determines (722) that the human subject is gazing at the second side, wherein the first type of impression count is updated to the second type of impression count in accordance with a determination that the human subject is gazing at the second side. In some embodiments, the display of the second side is updated in accordance with a determination that the human subject is gazing at the second side. In some embodiments, a timestamp is stored at a time when the human stops gazing at the first side. In some embodiments, a length of a gaze updates the second type of impression count to a third type of impression count (e.g., it is more valuable to know how long a person looked at the content). In some embodiments, the device does not use facial recognition.

The device stores (724) the respective type of impression count. For example, if the device determines the human subject has only been in an area in front of (e.g., and/or gazed at) the first side, a first type of impression count is stored (e.g., and/or transmitted to a server system, such as server 120). If the device determines that the human subject has been in an area in front of the first side and an area in front of the second side, a second type of impression count is stored (e.g., and/or transmitted to a server system).

In some embodiments, in accordance with the determination that the human subject moves from the position within the first field of view relative to the first side of the device to a position within a second field of view relative to a second side of the at least two sides, the device updates (726) display of the second side to display second content. In some embodiments, the device updates the display of the second side to display a continuation of the content that was displayed on the display of the first side (e.g., video content playing on the display of the first side is paused on the first side and is resumed on the second side). In some embodiments, the second content is related content (e.g., for a related product) to the content displayed on the display of the first side.

In some embodiments, updating display of the second side to display second content comprises (728), in accordance with a determination that the human subject moves from a position within the first field of view relative to the first side to a position outside of the first field of view, pausing the display of the first content and in accordance with a determination that the human subject moves to a position within a second field of view relative to a second side, updating display of the second side to display the first content resumed from a paused position.

In some embodiments, the second content is selected (730) based on the first content. For example, in accordance with a determination that the human subject gazed at the first content (e.g., or otherwise indicates interest in the first content), the device selects content similar to the first content. In some embodiments, in accordance with a determination that the human subject did not gaze at the first content, the device selects different, unrelated content (e.g., that the human subject may be more interested in).

In some embodiments, the second content is the same (732) as the first content.

In some embodiments, in accordance with a determination that the human subject does not move from the position in front of the first side to the position in front of the second side, the device forgoes updating (734) the first type of impression count to the second type of impression count (e.g., and stores the first impression count). For example, the second type of impression count is only stored in accordance with a determination that the human subject has been exposed to both the first side and the second side.

In some embodiments, the display of the second side displays the first content and the device, in response to determining that the human is facing the second side, replaces (736) display of the first content on the display of the second side with display of second content on the display of the second side.

It will be understood that, although the terms first, second, etc., are, in some instances, used herein to describe various elements, these elements should not be limited by these terms. These terms are only used to distinguish one element from another. For example, a first beacon signal could be termed a second beacon signal, and, similarly, a second beacon signal could be termed a first beacon signal, without departing from the scope of the various described embodiments. The first beacon signal and the second beacon signal are both beacon signals, but they are not the same condition unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a device having at least one camera and at least two sides, each side including a respective display:
detecting, using the at least one camera, a human subject at a position within a first field of view relative to a first side of the at least two sides, the first side displaying first content on a first display of the first side;
in response to detecting the human subject at the position within the first field of view relative to the first side:
generating a first type of impression count for the human subject; and
tracking, using the camera, motion of the human subject;
after detecting the human subject at the position within the first field of view relative to the first side, in accordance with a determination that the human subject moves from the position within the first field of view relative to the first side of the device to a position within a second field of view relative to a second side of the at least two sides, updating the first type of impression count to a second type of impression count; and
storing the respective type of impression count.

2. The method of claim 1, further comprising, in accordance with the determination that the human subject moves from the position within the first field of view relative to the first side of the device to a position within a second field of view relative to a second side of the at least two sides, updating display of the second side to display second content.

3. The method of claim 2, wherein updating display of the second side to display second content comprises:
in accordance with a determination that the human subject moves from a position within the first field of view relative to the first side to a position outside of the first field of view, pausing the display of the first content; and
in accordance with a determination that the human subject moves to a position within a second field of view relative to a second side, updating display of the second side to display the first content resumed from a paused position.

4. The method of claim 2, wherein the second content is selected based on the first content.

5. The method of claim 2, wherein the second content is the same as the first content.

6. The method of claim 1, further comprising, in accordance with a determination that the human subject does not move from the position in front of the first side to the position in front of the second side, forgoing updating the first type of impression count to the second type of impression count.

7. The method of claim 1, further comprising, wherein the second type of impression count is weighed as a greater impression count than the first type of impression count.

8. The method of claim 1, wherein the first and second sides are substantially parallel.

9. The method of claim 1, further comprising, after determining that the human subject moves from the position within the first field of view relative to the first side of the device to a position within a second field of view relative to a second side of the at least two sides, determining that the human subject is gazing at the second side, wherein the first type of impression count is updated to the second type of impression count in accordance with a determination that the human subject is gazing at the second side.

10. The method of claim 1, wherein tracking motion of the human subject includes capturing at least two images using the at least one camera and stitching the at least two images together.

11. The method of claim 1, wherein the at least one camera comprises two cameras, each camera capable of detecting at least 180 degrees.

12. The method of claim 1, wherein the display of the second side displays the first content; and the method further comprises, in response to determining that the human subject is facing the second side, replacing display of the first content on the display of the second side with display of second content on the display of the second side.

13. A device, comprising:
at least one camera;
at least two sides, each side including a respective display;
one or more processors; and
memory storing instructions for execution by the one or more processors, the instructions including instructions for:
detecting, using the at least one camera, a human subject at a position within a first field of view relative to a first side of the at least two sides, the first side displaying first content on a first display of the first side;
in response to detecting the human subject at the position within the first field of view relative to the first side:
generating a first type of impression count for the human subject; and
tracking, using the camera, motion of the human subject;
after detecting the human subject at the position within the first field of view relative to the first side, in accordance with a determination that the human subject moves from the position within the first field of view relative to the first side of the device to a position within a second field of view relative to a second side of the at least two sides, updating the first type of impression count to a second type of impression count; and
storing the respective type of impression count.

14. A non-transitory computer-readable storage medium storing one or more programs comprising instructions, executable by a device having at least one camera and at least two sides, each side including a respective display, and one or more processors, for:
detecting, using the at least one camera a human subject at a position within a first field of view relative to a first side of the at least two sides, the first side displaying first content on a first display of the first side;
in response to detecting a human subject at the position within the first field of view relative to the first side:
generating a first type of impression count for the human subject; and
tracking, using the camera, motion of the human subject;
after detecting the human subject at the position within the first field of view relative to the first side, in accordance with a determination that the human subject moves from the position within the first field of view relative to the first side of the device to a position within a second field of view relative to a second side of the at least two sides, updating the first type of impression count to a second type of impression count; and
storing the respective type of impression count.
